(19) United States
(12) Patent Application Publication
(10) Pub. No.: US 2018/0139032 A1
(43) Pub. Date: May 17, 2018

(54) COMMUNICATION DEVICE AND RECEIVING METHOD

(71) Applicant: FUJITSU LIMITED, Kawasaki-shi (JP)

(72) Inventors: Hiroyoshi ISHIKAWA, Kawasaki (JP); Yuichi UTSUNOMIYA, Kawasaki (JP); Akifumi ADACHI, Kawasaki (JP); Yusuke TOBISU, Yokohama (JP); Yuta TERANISHI, Fukuoka (JP); Yusuke OKI, Kawasaki (JP)

(73) Assignee: FUJITSU LIMITED, Kawasaki-shi (JP)

(21) Appl. No.: 15/783,790

(22) Filed: Oct. 13, 2017

(30) Foreign Application Priority Data
Nov. 11, 2016 (JP) 2016-220788

(51) Int. Cl. H04L 5/14

(52) U.S. Cl. CPC H04L 5/1461; H04B 17/103; H04L 5/143

(57) ABSTRACT

A communication device includes a transmitter to transmit a radio transmission signal having a frequency different from a frequency of a radio transmission signal transmitted by another transmitter, a receiver to receive a receiving signal including a primary signal and a first passive intermodulation signal generated by radio transmission signals, a memory, and a processor coupled to the memory and the processor to calculate a power of the primary signal, update a first coefficient for generating a cancel signal for canceling the first passive intermodulation signal, based on the receiving signal and transmission signals to be transmitted, generate the cancel signal based on the transmission signals and the first coefficient, and combine the receiving signal and the cancel signal, wherein the processor is further to adjust a step coefficient, which is a time constant in case of updating the first coefficient, based on the power of the calculated primary signal.

### CROSS-REFERENCE TO RELATED APPLICATION

This application is based upon and claims the benefit of priority of the prior Japanese Patent Application No. 2016-220788, filed on Nov. 11, 2016, the entire contents of which are incorporated herein by reference.

### FIELD

The embodiments discussed herein are related to a communication device and a receiving method.

### BACKGROUND

In the related art, in some cases, a duplexer may be installed in a radio communication device that shares a transmission antenna with a receiving antenna. That is, when the frequency of a transmission signal is different from the frequency of a receiving signal, the duplexer is connected to the antenna so that a transmission path and a receiving path in the radio communication device are electrically separated from each other. This can suppress the transmission signal from interfering with the receiving signal, thereby suppressing the deterioration of quality of receiving signal.

However, in recent years, a multi-carrier transmission has been put into a practical use in which signals are transmitted by a plurality of carriers each having different frequencies. In the multi-carrier transmission, since a transmission signal includes signals each having different frequencies, a passive intermodulation signal may be generated by passive intermodulation of these signals having different frequencies. The passive intermodulation signal generated from the transmission signal may leak into a receiving path and deteriorate quality of receiving signal. In particular, when the frequency of the passive intermodulation signal generated from the transmission signal is included in a frequency band of a receiving signal, there is a difficulty in accurate demodulation and decoding of the receiving signal.

A duplexer, an antenna and a cable connecting them with each other are passive elements, which are less likely to contribute to nonlinear distortion as compared to active elements such as amplifiers or the like. However, due to a minute impedance change or nonlinear characteristics in these passive elements, the passive intermodulation signal generated from the transmission signal may leak into the receiving path and deteriorate the quality of receiving signal. In addition, the passive intermodulation signal generated from the transmission signal may be reflected toward the receiving path by metal or the like located outside the radio communication device, thereby deteriorating the quality of receiving signal. For the purpose of avoiding these problems, it has been considered to approximately reproduce a passive intermodulation signal from a transmission signal and an interference signal, and cancel a different passive intermodulation signal by the reproduced passive intermodulation signal. The passive intermodulation signal reproduced from the transmission signal and the interference signal is adaptively controlled by, for example, an adaptive filter so that an error between the reproduced passive intermodulation signal and a passive intermodulation signal included in a receiving signal becomes small.

Related technologies are disclosed in, for example, Japanese National Publication of International Patent Application No. 2009-526442 and 3GPP TR37.808 V12.0.0 “Passive Intermodulation (PIM) handling for Base Stations (BS) (Release 12)”.

### SUMMARY

According to an aspect of the invention, a communication device includes a plurality of transmitters, a transmitter of the plurality of transmitters configured to transmit a radio transmission signal having a frequency different from a frequency of a radio transmission signal transmitted by another transmitter of the plurality of transmitters, a plurality of receivers, a receiver of the plurality of receivers configured to receive a receiving signal including a primary signal and a first passive intermodulation signal generated by a plurality of radio transmission signals, a memory, and a processor coupled to the memory and the processor configured to calculate a power of the primary signal, update a first coefficient for generating a cancel signal for canceling the first passive intermodulation signal, based on the receiving signal and a plurality of transmission signals to be transmitted by the plurality of transmitters, generate the cancel signal based on the plurality of transmission signals and the first coefficient, and combine the receiving signal and the cancel signal, wherein the processor is further configured to adjust a step coefficient, which is a time constant in case of updating the first coefficient, based on the power of the calculated primary signal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a communication device;

FIG. 2 is a view illustrating an example of a PIM signal included in a receiving signal;

FIG. 3 is a block diagram illustrating an example of a PIM cancel unit according to a first embodiment;

FIG. 4 is a diagram illustrating an example of a change in a PIM signal in a comparative example;

FIG. 5 is a view illustrating an example of a change in the PIM signal according to the first embodiment;

FIG. 6 is a graph illustrating an example of convergence time.

FIG. 7 is a flowchart illustrating an example of a process performed by a communication device of the first embodiment;

FIG. 8 is a block diagram illustrating another example of the PIM cancel unit according to the first embodiment;

FIG. 9 is a block diagram illustrating an example of a PIM cancel unit according to a second embodiment;

FIG. 10 is a flowchart illustrating an example of a process performed by a communication device of the second embodiment;

FIG. 11 is a block diagram illustrating another example of the PIM cancel unit according to the second embodiment;

FIG. 12 is a flowchart illustrating an example of a process performed by a communication device according to a third embodiment;

FIG. 13 is a flowchart illustrating an example of a process performed by a communication device according to a fourth embodiment;

FIG. 14 is a block diagram illustrating an example of a PIM cancel unit according to a fifth embodiment;

FIG. 15 is a flowchart illustrating an example of a process performed by a communication device of the fifth embodiment;

FIG. 16 is a block diagram illustrating an example of a PIM cancel unit according to a sixth embodiment;

FIG. 17 is a flowchart illustrating an example of a process performed by a communication device of the sixth embodiment;

FIG. 18 is a block diagram illustrating an example of a PIM cancel unit according to a seventh embodiment;

FIG. 19 is a view illustrating an example of a delay profile;

FIG. 20 is a flowchart illustrating an example of a process performed by a communication device of the seventh embodiment; and

FIG. 21 is a view illustrating an example of hardware of a PIM cancel unit.

### DESCRIPTION OF EMBODIMENTS

In a radio communication device such as a base station, in addition to an uplink signal transmitted from a wireless terminal device, a passive intermodulation signal generated from a signal transmitted by the base station is superimposed on a signal received from an antenna. Based on the passive intermodulation signal superimposed on the uplink signal, the base station generates a cancel signal for canceling the passive intermodulation signal. At this time, the uplink signal received at the base station interferes for obtaining a coefficient of the cancel signal. Therefore, when the uplink signal received at the base station is much larger than the passive intermodulation signal superimposed on the uplink signal, it is difficult to obtain the coefficient of the cancel signal with high accuracy. Therefore, even if the cancel signal is combined to a receiving signal, it is difficult to cancel the passive intermodulation signal superimposed on the receiving signal with high accuracy. As a result, the quality of the receiving signal is deteriorated due to the passive intermodulation signal component remaining in the receiving signal.

Hereinafter, embodiments of techniques of the present application capable of improving the quality of a receiving signal will be described in detail with reference to the accompanying drawings. It is, however, noted that the following embodiments do not limit the technical scope of the present disclosure.

### First Embodiment

[Communication Device 10]

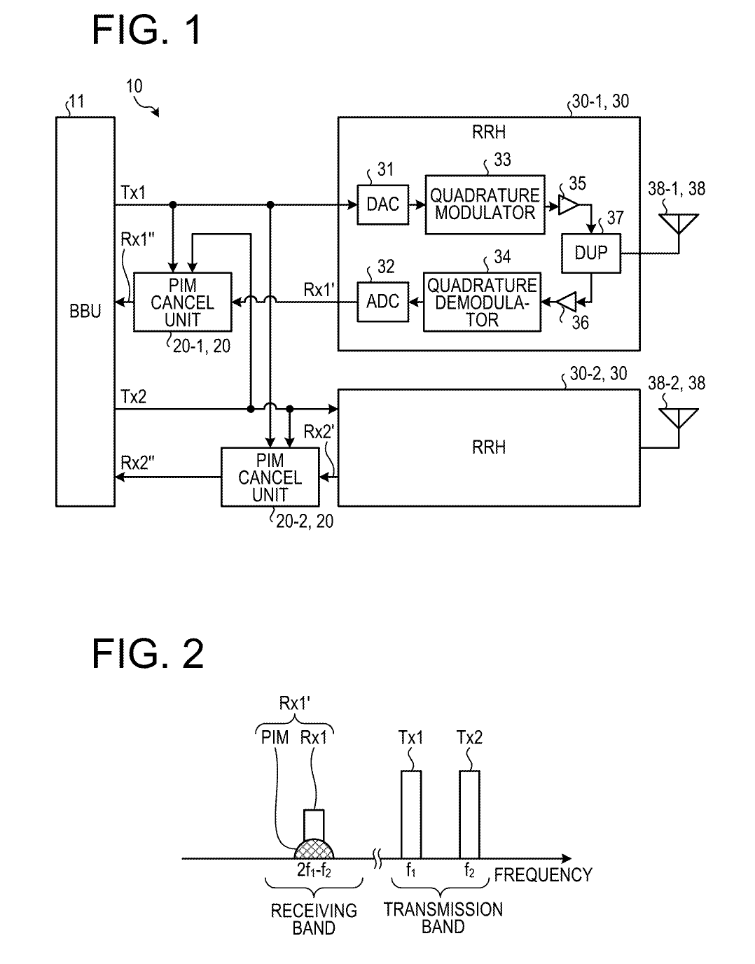

FIG. 1 is a block diagram illustrating an example of a communication device 10. The communication device 10 includes a base band unit (BBU) 11, passive intermodulation (PIM) cancel units 20-1 to 20-2, remote radio heads (RRHs) 30-1 to 30-2 and antennas 38-1 to 38-2. The communication device 10 in this embodiment is a radio base station used, for example, for a radio communication system. The RRHs 30-1 to 30-2 transmit transmission signals having different frequencies. In this embodiment, the RRH 30-1 transmits a transmission signal Tx1 of a frequency f₁ via the antenna 38-1 and the RRH 30-2 transmits a transmission signal Tx2 with a frequency f₂ via the antenna 38-2. In the following description, it is assumed that f₂ is higher than f₁ (f₁<f₂). In the following description, the PIM cancel units 20-1 to 20-2 are collectively referred to as a PIM cancel unit 20 unless distinguished from each other, the RRHs 30-1 to 30-2 are collectively referred to as a RRH 30 unless distinguished from each other, and the antennas 38-1 to 38-2 are collectively referred to as an antenna 38 unless distinguished from each other.

Each RRH 30 includes a digital to analog converter (DAC) 31, an analog to digital converter (ADC) 32, a quadrature modulator 33, a quadrature demodulator 34, a power amplifier (PA) 35, a low noise amplifier (LNA) 36 and a duplexer (DUP) 37. Each RRH 30 is an example of a transmitter and a receiver.

The DAC 31 converts a digital transmission signal output from the BBU 11 into an analog signal which is then output to the quadrature modulator 33. The quadrature modulator 33 quadrature-modulates the transmission base band signal converted into the analog signal by the DAC 31. The PA 35 amplifies the transmission signal which has been quadrature-modulated by the quadrature modulator 33. The DUP 37 passes the frequency component of a transmission band in the transmission signal amplified by the PA 35 to the antenna 38. This allows the RRH 30-1 to transmit the transmission signal Tx1 having the frequency f₁ via the antenna 38-1, and allows the RRH 30-2 to transmit the transmission signal Tx2 having the frequency f₂ via the antenna 38-2.

In addition, the DUP 37 passes the frequency component of a receiving band in a receiving signal received via the antenna 38 to the LNA 36. The LNA 36 amplifies the receiving signal output from the DUP 37. The quadrature demodulator 34 quadrature-demodulates the receiving signal amplified by the LNA 36. The ADC 32 converts the analog receiving signal which has been quadrature-demodulated by the quadrature demodulator 34 into a digital signal, and outputs the receiving signal converted into the digital signal to the PIM cancel unit 20. The ADC 32 of the RRH 30-1 outputs a receiving signal Rx1′ converted into a digital signal to the PIM cancel unit 20-1, and the ADC 32 of the RRH 30-2 outputs a receiving signal Rx2′ converted into a digital signal to the PIM cancel unit 20-2.

The receiving signal output from each RRH 30 includes a receiving signal received from another communication device such as a wireless terminal of the communication counterpart and PIM signals which are passive intermodulation signals generated by a plurality of transmission signals Tx1 and Tx2. FIG. 2 is a view illustrating an example of a PIM signal included in a receiving signal. When the transmission signal Tx1 of the frequency f₁ transmitted from the RRH 30-1 via the antenna 38-1 and the transmission signal Tx2 of the frequency f₂ transmitted from the RRH 30-2 via the antenna 38-2 are reflected to an external PIM source, a PIM signal having a frequency of 2f₁−f₂, 2f₂−f₁, or the like may be generated. Depending on the frequencies of f₁ and f₂, for example, the frequency of 2f₁−f₂ or 2f₂−f₁ may be included in a receiving band, as illustrated in FIG. 2. Therefore, for example, as illustrated in FIG. 2, the receiving signal Rx1′ may include a PIM signal in addition to the receiving signal Rx1 (for example, a primary signal) such as an uplink signal transmitted from a wireless terminal of the communication counterpart.

Returning to FIG. 1, the PIM cancel unit 20-1 acquires from the BBU 11 the transmission signal Tx1 transmitted by the RRH 30-1 via the antenna 38-1 and the transmission signal Tx2 transmitted by the RRH 30-2 via the antenna 38-2. Then, based on the transmission signals Tx1 and Tx2, the PIM cancel unit 20-1 generates a cancel signal which is a replica of the PIM signal generated by the transmission signals Tx1 and Tx2. Then, the PIM cancel unit 20-1 reduces the PIM signal included in the receiving signal Rx1′ by combining the generated cancel signal with the receiving signal Rx1′ output from the RRH 30-1. Then, the PIM cancel unit 20-1 outputs a receiving signal Rx1″ with the reduced PIM signal to the BBU 11.

Similarly, the PIM cancel unit 20-2 acquires from the BBU 11 the transmission signal Tx1 transmitted by the RRH 30-1 via the antenna 38-1 and the transmission signal Tx2 transmitted by the RRH 30-2 via the antenna 38-2 and generates a PIM signal based on the transmission signals Tx1 and Tx2. Then, the PIM cancel unit 20-2 reduces the PIM signal included in the receiving signal Rx2′ by combining the generated cancel signal with the receiving signal Rx2′ output from the RRH 30-2. Then, the PIM cancel unit 20-2 outputs a receiving signal Rx2″ with the reduced PIM signal to the BBU 11.

In the following description, the receiving signal Rx1′ output from the RRH 30-1 and the receiving signal Rx2′ output from the RRH 30-2 are collectively referred to as a receiving signal Rx′ unless distinguished from each other. In addition, the receiving signal Rx1″ output from the PIM cancel unit 20-1 and the receiving signal Rx2″ output from the PIM cancel unit 20-2 are collectively referred to as a receiving signal Rx″ unless distinguished from each other.

[PIM Cancel Unit 20]

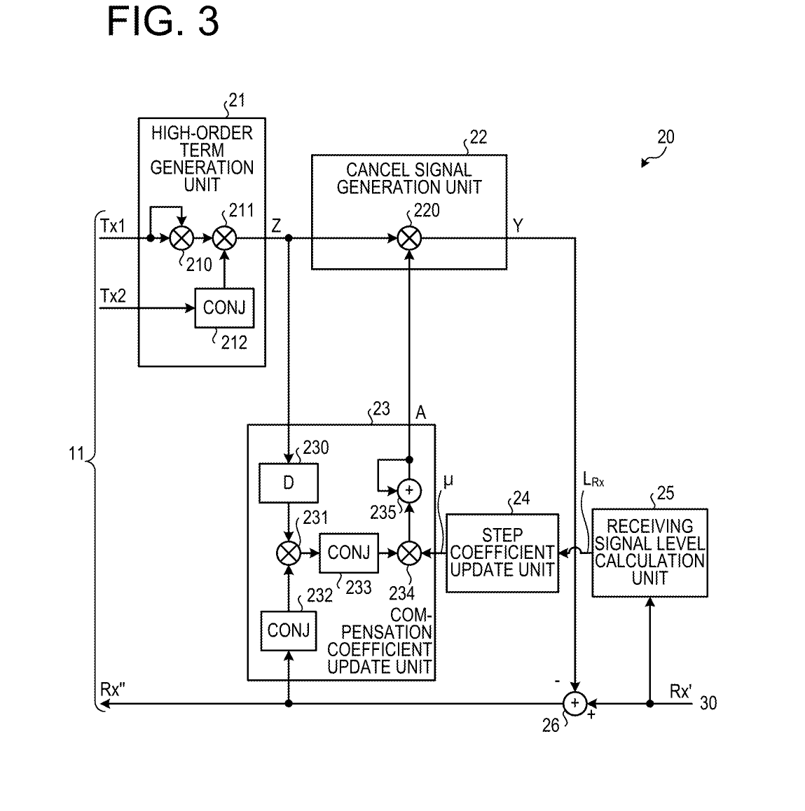

FIG. 3 is a block diagram illustrating an example of the PIM cancel unit 20 according to the first embodiment. As illustrated in, for example, FIG. 3, the PIM cancel unit 20 of the present embodiment includes a high-order term generation unit 21, a cancel signal generation unit 22, a compensation coefficient update unit 23, a step coefficient update unit 24, a receiving signal level calculation unit 25, and a combination unit 26. In the following, the reduction of the PIM signal of the frequency of 2f₁−f₂ will be described. However, the reduction of the PIM signal of the frequency of 2f₂−f₁ may also be achieved in the same manner by exchanging f₁ and f₂.

The receiving signal level calculation unit 25 calculates a signal level L_{Rx} of the receiving signal Rx′, for example, according to the following equation (1). In this embodiment, the receiving signal level calculation unit 25 calculates the amplitude of the receiving signal Rx′ as the signal level L_{Rx}.

$$\begin{matrix}Equation 1 & \\ {L}_{Rx} = \sqrt{\sum {( {Rx}^{′} )}^{2}} & ( 1 )\end{matrix}$$

The step coefficient update unit 24 updates a step coefficient μ, which is a time constant when a compensation coefficient A of the cancel signal is compensated, based on the signal level L_{Rx} of the receiving signal Rx′ calculated by the receiving signal level calculation unit 25. For example, the step coefficient update unit 24 adjusts a value of the step coefficient μ to be smaller as the signal level L_{Rx} becomes larger, and to be larger as the signal level L_{Rx} becomes smaller. Specifically, the step coefficient update unit 24 updates the value of the step coefficient μ, which is a time constant when the compensation coefficient A of the cancel signal is compensated, for example, according to the following equation (2).

$$\begin{matrix}Equation 2 & \\ μ = \frac{{L}_{0}}{{L}_{Rx}} \times {μ}_{0} & ( 2 )\end{matrix}$$

In the equation (2), L₀ is a constant indicating a value of a predetermined signal level and μ₀ is a constant indicating a value of a predetermined step coefficient. The values of L₀ and μ₀ are set in advance in the step coefficient update unit 24 by a manager of the communication device 10.

The high-order term generation unit 21 acquires the transmission signals Tx1 and Tx2 from the BBU 11 and generates a high-order term component Z in the PIM signal, based on the acquired transmission signals Tx1 and Tx2, for example, according to the following equation (3).

Equation 3

Z=Tx1×Tx1×conj(Tx2) (3)
In the equation (3), conj (x) represents the complex conjugate of x.

In the present embodiment, the high-order term generation unit 21 calculates the third-order term component in the PIM signal as Z. However, as another example, the high-order term generation unit 21 may generate a component in the PIM signal up to a term of the order higher than the third order as Z.

Specifically, for example, as illustrated in FIG. 3, the high-order term generation unit 21 includes a multiplier 210, a multiplier 211, and a complex conjugate calculator 212. The multiplier 210 calculates the square of the transmission signal Tx1 acquired from the BBU 11. The complex conjugate calculator 212 calculates the complex conjugate of the transmission signal Tx2 acquired from the BBU 11. The multiplier 211 generates the high-order term component Z in the PIM signal by multiplying the square of the transmission signal Tx1 calculated by the high-order term generation unit 21 and the complex conjugate of the transmission signal Tx2 calculated by the complex conjugate calculator 212. The multiplier 210 and the multiplier 211 are, for example, complex multipliers.

The compensation coefficient update unit 23 uses the high-order term component Z calculated by the high-order term generation unit 21 and the step coefficient μ updated by the step coefficient update unit 24 to update the compensation coefficient A for compensating the phase and amplitude of the cancel signal, for example, according to the following equation (4). In this embodiment, the compensation coefficient A is a coefficient of the third order term in the PIM signal.

Equation 4

A=A+μconj(conj(Rx′)×Z) (4)
In the equation (4), Rx″ represents a receiving signal output from the combination unit 26 to be described later.

Specifically, for example, as illustrated in FIG. 3, the compensation coefficient update unit 23 includes a delay unit 230, a multiplier 231, a complex conjugate calculator 232, a complex conjugate calculator 233, a multiplier 234, and an adder 235. The delay unit 230 delays the high-order term component Z calculated by the high-order term generation unit 21 for a predetermined period of time. The complex conjugate calculator 232 calculates the complex conjugate of the receiving signal Rx″ output from the combination unit 26. The multiplier 231 multiplies the high-order term component Z delayed by the delay unit 230 and the complex conjugate of the receiving signal Rx″ calculated by the complex conjugate calculator 232.

The complex conjugate calculator 233 calculates the complex conjugate of a multiplication result by the multiplier 231. The multiplier 234 multiplies the complex conjugate of the multiplication result by the multiplier 231 and the step coefficient μ updated by the step coefficient update unit 24. The adder 235 updates the compensation coefficient A by adding the compensation coefficient A before update and the multiplication result by the multiplier 234. The updated compensation coefficient A is output to the cancel signal generation unit 22. The multipliers 231 and 234 are, for example, complex multipliers.

The cancel signal generation unit 22 includes a multiplier 220. The multiplier 220 generates a cancel signal Y by multiplying the high-order term component Z of the PIM signal output from the high-order term generation unit 21 by the compensation coefficient A updated by the compensation coefficient update unit 23. The generated cancel signal Y is output to the combination unit 26. The multiplier 220 is, for example, a complex multiplier.

The combination unit 26 reduces the PIM signal included in the receiving signal Rx′ by combining the cancel signal Y output from the cancel signal generation unit 22 and the receiving signal Rx′ output from the RRH 30. Specifically, the combination unit 26 reduces the PIM signal included in the receiving signal Rx′ by subtracting the cancel signal Y output from the cancel signal generation unit 22 from the receiving signal Rx′ output from the RRH 30. Then, the combination unit 26 outputs the receiving signal Rx″ with the reduced PIM signal to the compensation coefficient update unit 23 and the BBU 11.

Here, the PIM signal included in the receiving signal Rx′ is generated when the transmission signals Tx1 and Tx2 transmitted from each RRH 30 are reflected to the PIM source, but the signal level of a PIM signal received in each RRH 30 is not so large. In addition, when the communication terminal 10 and the wireless terminal of the communication counterpart are separated from each other, the signal level of a receiving signal Rx received from the wireless terminal or the like is also small. Therefore, reducing the PIM signal included in the receiving signal Rx′ is effective in improving the receiving quality of the receiving signal.

In order to reduce the PIM signal included in the receiving signal Rx′, a cancel signal Y is generated based on a plurality of transmission signals Tx1 and Tx2 that generate the PIM signal. Then, the compensation coefficient A indicating the phase and the amplitude of the cancel signal Y is adjusted so that the component of the PIM signal included in a combination signal of the cancel signal Y and the receiving signal Rx′ becomes smaller.

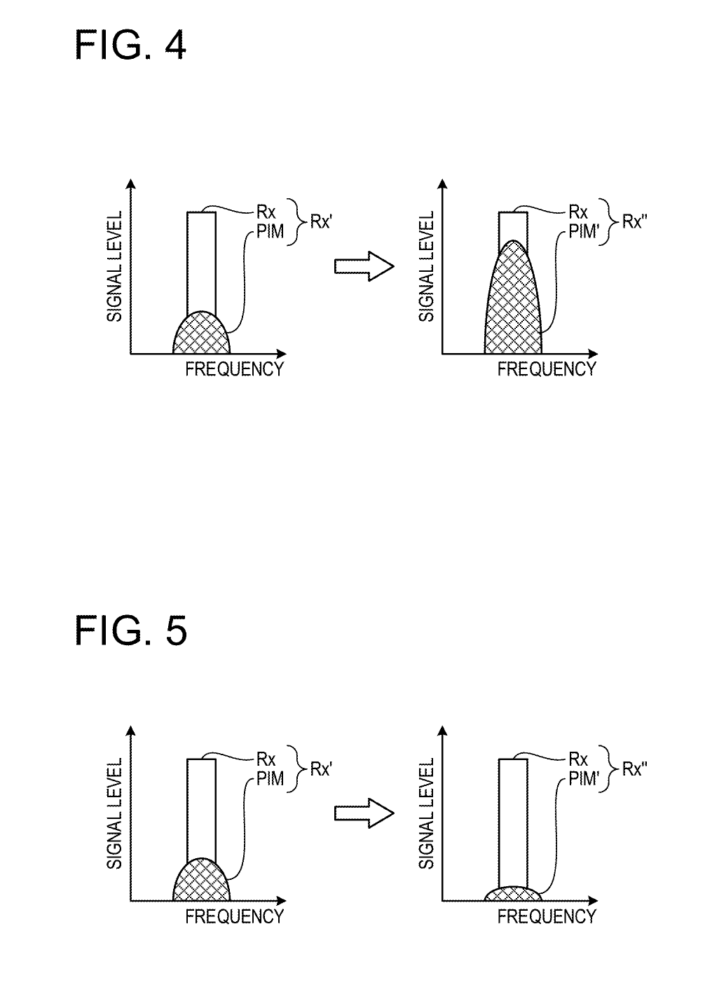

Here, as the signal level of the receiving signal Rx received from the wireless terminal or the like becomes larger, such as when the wireless terminal or the like of the communication counterpart is located near the communication device 10, the accuracy of detection of a component of the PIM signal included in the receiving signal Rx′ becomes lower. For example, as illustrated in the left side of FIG. 4, when the signal level of the receiving signal Rx in the receiving signal Rx′ is large, the phase and amplitude of the cancel signal may not converge but diverge. As a result, for example, as illustrated in the right side of FIG. 4, the PIM signal included in the receiving signal Rx″ after the cancel signal is combined may increase inversely. FIG. 4 is a view illustrating an example of a change in the PIM signal in a comparative example.

Therefore, in this embodiment, the signal level of the receiving signal Rx′ including the PIM signal is measured and the step coefficient μ, which is a time constant when the compensation coefficient A of the cancel signal Y is updated, is adjusted based on the measured signal level of the receiving signal Rx′. For example, the step coefficient μ is adjusted to become larger as the measured signal level of the receiving signal Rx′ becomes smaller. Accordingly, the convergence time of the compensation coefficient A becomes shorter. Meanwhile, the step coefficient μ is adjusted to become smaller as the measured signal level of the receiving signal Rx′ becomes larger. When the step coefficient μ becomes smaller, the convergence time is lengthened but the accuracy of calculation of the compensation coefficient applied to the cancel signal Y is improved. Therefore, for example, as illustrated in the left side of FIG. 5, even when the level of the receiving signal Rx in the receiving signal Rx′ is large, the phase and amplitude of the cancel signal Y converge without diverging. As a result, for example, as illustrated in the right side of FIG. 5, even when the level of the receiving signal Rx in the receiving signal Rx′ is large, the PIM signal included in the receiving signal Rx″ after the cancel signal Y is combined is reduced. FIG. 5 is a view illustrating an example of a change in the PIM signal in the first embodiment.

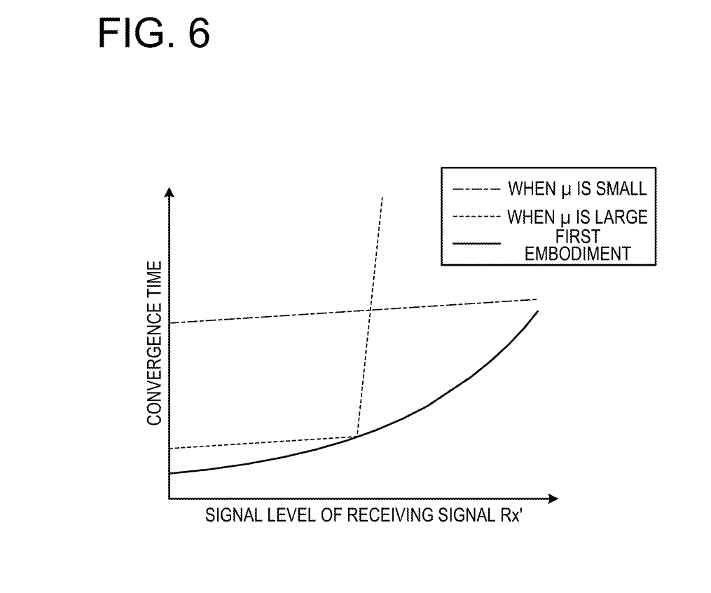

FIG. 6 is a view illustrating an example of the convergence time. When the step coefficient μ is fixed at a small value, for example, as indicated by a chain line in FIG. 6, even when the signal level of the receiving signal Rx′ is large, the compensation coefficient A converges with some degree of convergence time without diverging. However, when the value of the step coefficient μ is small, for example, as indicated by the chain line in FIG. 6, even when the signal level of the receiving signal Rx′ is small, it takes some time for convergence of the compensation coefficient A. The fact that it takes some time for convergence of the compensation coefficient A indicates that the number of signals received during the non-convergence period becomes large and the quality of receiving signal lowers.

In the meantime, when the step coefficient μ is fixed at a large value, for example, as indicated by a broken line in FIG. 6, when the signal level of the receiving signal Rx′ is small, the compensation coefficient A does not diverge but converges. A larger step coefficient μ provides a shorter convergence time of the compensation coefficient A than a smaller step coefficient μ. However, when the value of the step coefficient μ is large, for example, as indicated by the broken line in FIG. 6, when the signal level of the receiving signal Rx′ is equal to or greater than a certain level, the compensation coefficient A may not converge but diverge, thereby lowering the quality of the receiving signal.

In this embodiment, the step coefficient μ is adjusted to become smaller as the signal level of the receiving signal Rx′ including the receiving signal Rx and the PIM signal becomes larger, whereas the step coefficient μ is adjusted to become larger as the signal level of the receiving signal Rx′ becomes smaller. Accordingly, for example, as indicated by a solid line in FIG. 6, the compensation coefficient A may be converged without being diverged, regardless of the magnitude of the signal level of the receiving signal Rx′, thereby improving the quality of receiving signal. In addition, since the step coefficient μ is adjusted to be larger as the signal level of the receiving signal Rx′ becomes smaller, it is possible to shorten the convergence time as compared with a case where the step coefficient μ is fixed at a small value, thereby improving the quality of receiving signal.

[Process of Communication Device 10]

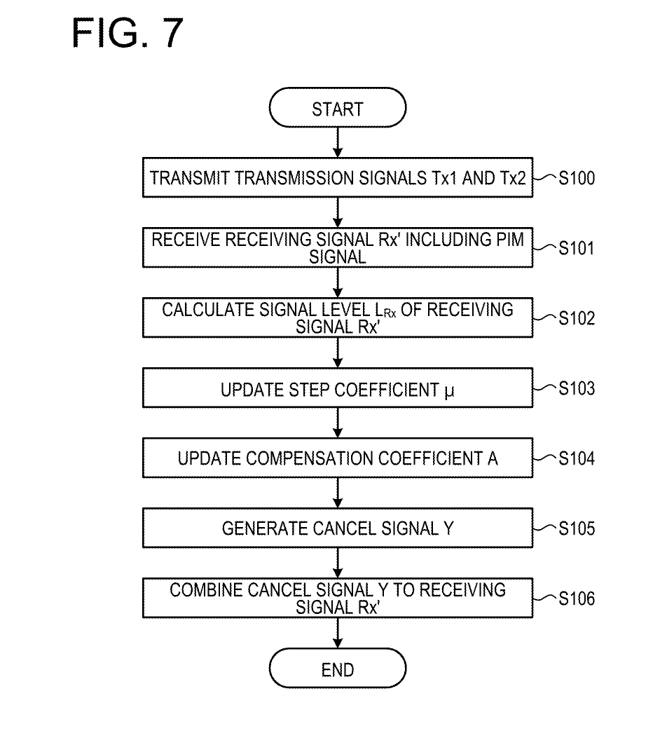

FIG. 7 is a flowchart illustrating an example of a process performed by the communication device 10 of the first embodiment. The communication device 10 performs the process illustrated in the flowchart of FIG. 7 every predetermined timing. In the flowchart of FIG. 7, the process of the PIM cancel unit 20-1 and the RRH 30-1 will be mainly described.

First, the BBU 11 outputs a transmission signal Tx1 to each of the PIM cancel unit 20 and the RRH 30-1. The transmission signal Tx1 is subjected to a process such as quadrature modulation or the like by the RRH 30-1 and is transmitted from the antenna 38-1 (S100). In addition, the BBU 11 outputs a transmission signal Tx2 to each of the PIM cancel unit 20 and the RRH 30-2. The transmission signal Tx2 is subjected to a process such as quadrature modulation or the like by the RRH 30-2 and is transmitted from the antenna 38-2 (S100).

Next, the RRH 30 receives a receiving signal Rx′ including a PIM signal via the antenna 38 (S101). The receiving signal Rx′ received by the RRH 30 is output to the PIM cancel unit 20.

Next, the receiving signal level calculation unit 25 of the PIM cancel unit 20 calculates a signal level L_{Rx} of the receiving signal Rx′, for example, according to the above-described equation (1) (S102). Then, the receiving signal level calculation unit 25 outputs the calculated signal level L_{Rx} to the step coefficient update unit 24.

Next, the step coefficient update unit 24 updates the step coefficient μ, for example, according to the above-described equation (2), based on the signal level L_{Rx} output from the receiving signal level calculation unit 25 (S103). Then, the step coefficient update unit 24 outputs the updated step coefficient μ to the compensation coefficient update unit 23.

Next, the high-order term generation unit 21 generates the high-order term component Z in the PIM signal, for example, according to the above-described equation (3), based on the transmission signals Tx1 and Tx2 output from the BBU 11. Then, the compensation coefficient update unit 23 uses the high-order term component Z calculated by the high-order term generation unit 21 and the step coefficient μ output from the step coefficient update unit 24 to update the compensation coefficient A, for example, according to the above-described equation (4) (S104).

Next, the cancel signal generation unit 22 generates a cancel signal Y by multiplying the high-order term component Z of the PIM signal output from the high-order term generation unit 21 by the compensation coefficient A updated by the compensation coefficient update unit 23 (S105). The generated cancel signal Y is output to the combination unit 26.

Next, the combination unit 26 combines the cancel signal Y output from the cancel signal generation unit 22 and the receiving signal Rx′ output from the RRH 30 to reduce the PIM signal included in the receiving signal Rx′ (S106). Then, the combination unit 26 outputs a receiving signal Rx″ with the reduced PIM signal to the compensation coefficient update unit 23 and the BBU 11. Then, the communication device 10 ends the process illustrated in the flowchart.

### Effects of First Embodiment

The first embodiment has been described above. The communication device 10 of the present embodiment includes the RRH 30 and the PIM cancel unit 20. The RRH 30 transmits a plurality of transmission signals wirelessly transmitted at different frequencies. In addition, the RRH 30 receives a receiving signal including a PIM signal generated by the plurality of transmission signals. The PIM cancel unit 20 includes the receiving signal level calculation unit 25, the step coefficient update unit 24, the compensation coefficient update unit 23, the cancel signal generation unit 22 and the combination unit 26. The receiving signal level calculation unit 25 calculates the signal level of the receiving signal received by the RRH 30. The compensation coefficient update unit 23 sequentially updates a coefficient for generating a cancel signal corresponding to the PIM signal, based on the plurality of transmission signals and the receiving signal transmitted by the RRH 30. The cancel signal generation unit 22 generates the cancel signal by using the plurality of transmission signals transmitted by the RRH 30 and the coefficient updated by the compensation coefficient update unit 23. The combination unit 26 combines the receiving signal and the cancel signal. Based on the signal level calculated by the receiving signal level calculation unit 25, the step coefficient update unit 24 adjusts a step coefficient which is a time constant when the coefficient for generating the cancel signal is updated. Accordingly, the communication device 10 may converge the compensation coefficient A without diverging it. In addition, the communication device 10 may shorten the convergence time of the compensation coefficient A as compared to a case where the step coefficient μ is fixed to a small value, thereby improving the quality of receiving signal.

The step coefficient update unit 24 of the present embodiment adjusts the value of the step coefficient μ to be smaller as the signal level of the receiving signal calculated by the receiving signal level calculation unit 25 becomes larger. Further, the step coefficient update unit 24 of this embodiment adjusts the value of the step coefficient μ to be larger as the signal level of the receiving signal calculated by the receiving signal level calculation unit 25 becomes smaller. Accordingly, the communication device 10 may converge the compensation coefficient A without diverging it and may shorten the convergence time of the compensation coefficient A.

[Other Examples of PIM Cancel Unit 20 of First Embodiment]

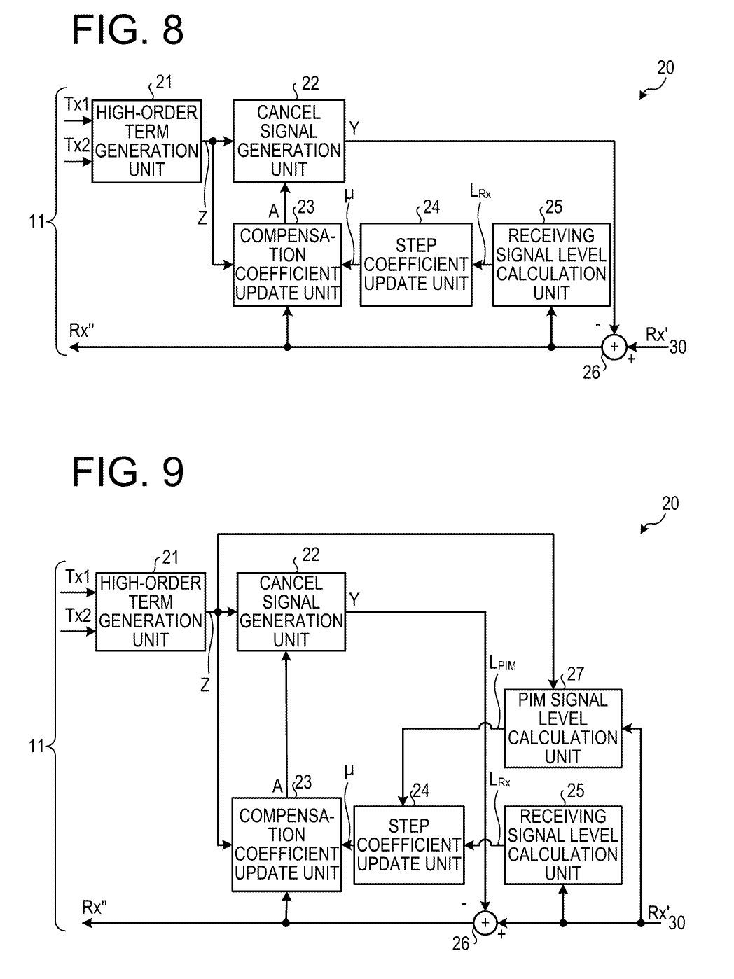

The receiving signal level calculation unit 25 in the first embodiment calculates the signal level L_{Rx} of the receiving signal Rx′ output from the RRH 30, but the present disclosure is not limited thereto. As another example, for example, as illustrated in FIG. 8, the receiving signal level calculation unit 25 may calculate the signal level L_{Rx} of the receiving signal Rx″ after the cancel signal Y output from the receiving signal generation unit 22 is combined to the receiving signal Rx′ output from the RRH 30.

### Second Embodiment

In the above-described first embodiment, the step coefficient μ is adjusted based on the value of the signal level L_{Rx} of the receiving signal Rx′. In contrast, a second embodiment is different from the first embodiment in that the step coefficient μ is adjusted based on a ratio of the value of the signal level L_{Rx} of the receiving signal Rx′ and a signal level L_{PIM} of the PIM signal. The following description is focused on the points different from the first embodiment. A communication device 10 in the second embodiment has the same configuration as the communication device 10 of the first embodiment described with reference to FIG. 1 and therefore, explanation of which will be omitted.

[PIM Cancel Unit 20]

FIG. 9 is a block diagram illustrating an example of a PIM cancel unit 20 according to the second embodiment. The PIM cancel unit 20 in the present embodiment includes a high-order term generation unit 21, a cancel signal generation unit 22, a compensation coefficient update unit 23, a step coefficient update unit 24, a receiving signal level calculation unit 25, a combination unit 26, and a PIM signal level calculation unit 27. Excluding the points to be described below, in FIG. 9, the blocks denoted by the same reference numerals as those in FIG. 3 have the same or similar functions as the blocks in FIG. 3 and therefore, explanation of which will be omitted.

The PIM signal level calculation unit 27 calculates a correlation value between a PIM signal generated from the plurality of transmission signals Tx1 and Tx2 transmitted by each RRH 30 and a receiving signal Rx′ including the PIM signal. Then, the PIM signal level calculation unit 27 calculates the signal level L_{PIM} of the PIM signal included in the receiving signal Rx′ by dividing the calculated correlation value by the magnitude of the PIM signal generated from the plurality of transmission signals Tx1 and Tx2 transmitted by each RRH 30.

Specifically, the PIM signal level calculation unit 27 calculates the signal level L_{PIM} of the PIM signal included in the receiving signal Rx′, for example, according to the following equation (5). In this embodiment, the receiving signal level calculation unit 25 calculates the amplitude of the PIM signal included in the receiving signal Rx′ as the signal level L_{PIM}.

$$\begin{matrix}Equation 5 & \\ {L}_{PIM} = \frac{\sum ( Z \times con j ( {Rx}^{′} ) )}{\sum \vert Z \vert} & ( 5 )\end{matrix}$$

In the equation (5), Z represents a high-order term component in the PIM signal calculated by the high-order term generation unit 21.

The step coefficient update unit 24 adjusts the step coefficient μ based on a value of the ratio of the signal level L_{Rx} of the receiving signal Rx′ calculated by the receiving signal level calculation unit 25 and the signal level L_{PIM} of the PIM signal calculated by the PIM signal level calculation unit 27. For example, the step coefficient update unit 24 adjusts the step coefficient μ to be smaller as the value of the ratio of the signal level L_{Rx} and the signal level L_{PIM} becomes larger, while adjusting the step coefficient μ to be larger as the value of the ratio of the signal level L_{Rx} and the signal level L_{PIM} becomes smaller. More specifically, the step coefficient update unit 24 uses the signal level L_{Rx} and the signal level L_{PIM} to update the step coefficient μ, for example, according to the following equation (6).

$$\begin{matrix}Equation 6 & \\ μ = \frac{{L}_{PIM}}{{L}_{Rx}} \times {μ}_{0} & ( 6 )\end{matrix}$$

Accordingly, when the value of the signal level PIM of the PIM signal is larger than the value of the signal level L_{Rx} of the receiving signal Rx′, the value of the step coefficient μ becomes larger, thereby shortening the convergence time of the compensation coefficient A. In the meantime, when the value of the signal level L_{PIM} of the PIM signal is smaller than the value of the signal level L_{Rx} of the receiving signal Rx′, the value of the step coefficient μ becomes smaller, thereby suppressing the compensation coefficient A from diverging.

[Process of Communication Device 10]

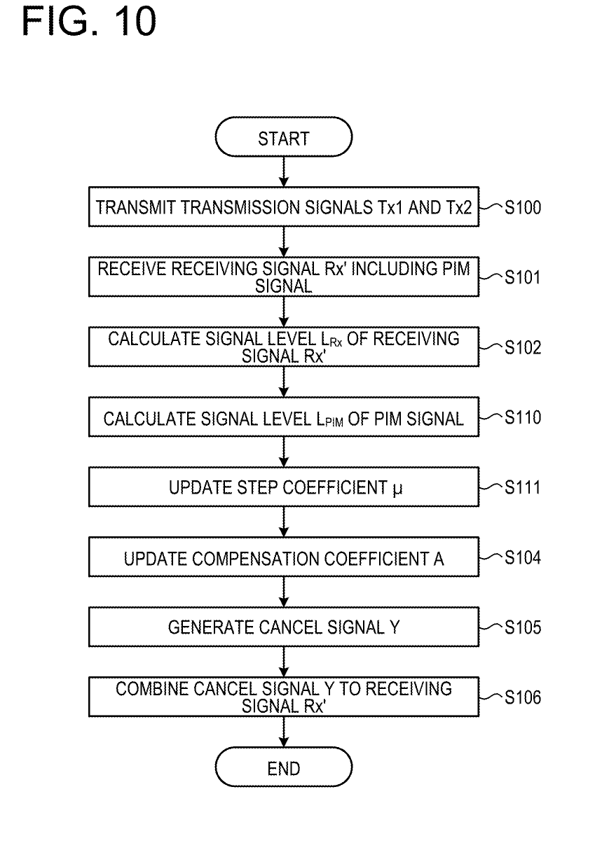

FIG. 10 is a flowchart illustrating an example of a process performed by the communication device 10 of the second embodiment. The communication device 10 performs the process illustrated in the flowchart of FIG. 10 every predetermined timing. In FIG. 10, steps denoted by the same reference numeral as in FIG. 7 have the same configurations as the steps illustrated in the flowchart of FIG. 7 and therefore, explanation of which will be omitted.

The PIM signal level calculation unit 27 calculates the signal level L_{PIM} of the PIM signal included in the receiving signal Rx′, for example, according to the above-described equation (5) (S110). Then, the PIM signal level calculation unit 27 outputs the calculated signal level L_{PIM} to the step coefficient update unit 24.

Next, the step coefficient update unit 24 calculates the step coefficient μ, for example, according to the above-described equation (6), based on the signal level L_{Rx} calculated by the receiving signal level calculation unit 25 and the signal level L_{PIM} calculated by the PIM signal level calculation unit 27 (S111). Then, the step coefficient update unit 24 outputs the updated step coefficient μ to the compensation coefficient update unit 23. Then, the communication device 10 executes the steps in the operations S104 to S106.

### Effects of Second Embodiment

The second embodiment has been described above. The communication device 10 of the present embodiment further includes the PIM signal level calculation unit 27. The PIM signal level calculation unit 27 calculates the signal level of a PIM signal included in a receiving signal by dividing a correlation value between a PIM signal generated from a plurality of transmission signals transmitted by the RRH 30 and a receiving signal by the magnitude of the PIM signal generated from the plurality of transmission signals transmitted by the RRH 30. The step coefficient update unit 24 adjusts the value of the step coefficient μ to be smaller as the ratio of the signal level of the receiving signal calculated by the receiving signal level calculation unit 25 and the signal level calculated by the PIM signal level calculation unit 27 becomes larger. Further, the step coefficient update unit 24 adjusts the value of the step coefficient μ to be larger as the ratio of the signal level of the receiving signal calculated by the receiving signal level calculation unit 25 and the signal level calculated by the PIM signal level calculation unit 27 becomes smaller. As a result, the communication device 10 may suppress the compensation coefficient A from diverging, while shortening the convergence time of the compensation coefficient A, thereby improving the quality of receiving signal.

[Other Examples of PIM Cancel Unit 20 of Second Embodiment]

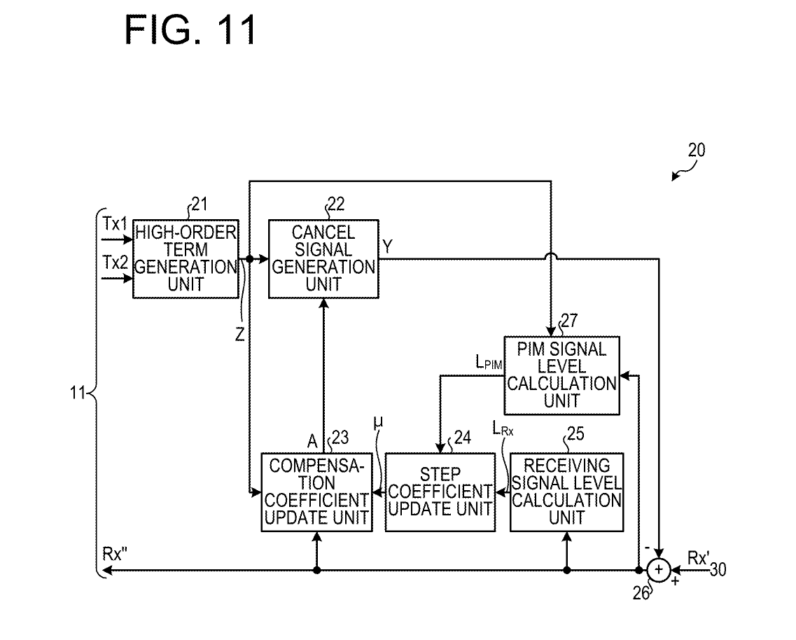

In the above-describe second embodiment, the receiving signal level calculation unit 25 calculates the signal level L_{Rx} of the receiving signal Rx′ output from the RRH 30 and the PIM signal level calculation unit 27 calculates the signal level L_{PIM}, of the PIM signal included in the receiving signal Rx′. However, the present disclosure is not limited thereto. As another example, as illustrated in FIG. 11, the receiving signal level calculation unit 25 and the PIM signal level calculation unit 27 may calculate the signal level L_{Rx} and the signal level L_{PIM}, respectively, based on the receiving signal Rx″ after the cancel signal Y is combined to the receiving signal Rx′.

In the example illustrated in FIG. 11, when the receiving signal Rx included in the receiving signal Rx′ is large, the receiving signal Rx″ after the canceled signal Y is combined also becomes large. Therefore, the signal level L_{Rx} calculated by the receiving signal level calculation unit 25 becomes large and the value of the step coefficient μ updated by the step coefficient update unit 24 becomes small. Accordingly, when the receiving signal Rx included in the receiving signal Rx′ is large, the value of the step coefficient μ is controlled to be small to suppress the compensation coefficient A from diverging.

When the compensation coefficient A updated by the compensation coefficient update unit 23 approaches the convergence, the component of the PIM signal included in the receiving signal Rx″ after the cancel signal Y is combined becomes smaller. Therefore, the signal level L_{PIM} calculated by the PIM signal level calculation unit 27 becomes smaller and the value of the step coefficient μ updated by the step coefficient update unit 24 also becomes smaller. Accordingly, in a stage where the compensation coefficient A updated by the compensation coefficient update unit 23 does not converge, the convergence time is shortened by adjusting the step coefficient μ to a large value. Then, as the compensation coefficient A approaches the convergence, the step coefficient μ is adjusted to a small value, thereby improving the accuracy of calculation of the compensation coefficient A. As a result, the communication device 10 may improve the quality of receiving signal.

### Third Embodiment

In the above-described first embodiment, irrespective of the value of the signal level L_{Rx} of the receiving signal Rx′, the step coefficient μ is updated based on the value of the signal level L_{Rx}. In contrast, a third embodiment is different from the first embodiment in that the step coefficient μ is updated to 0 when the value of the signal level L_{Rx} of the receiving signal Rx′ is larger than a preset threshold Lₜₕ. The following description is focused on the points different from the first embodiment. A communication device 10 in the third embodiment has the same configuration as the communication device 10 of the first embodiment described with reference to FIG. 1 and therefore, explanation of which will be omitted. In addition, excluding the points to be described below, a PIM cancel unit 20 in the third embodiment has the same configuration as the PIM cancel unit 20 of the first embodiment described with reference to FIG. 3 and therefore, explanation of which will be omitted.

The step coefficient update unit 24 of the present embodiment determines whether or not the signal level L_{Rx} calculated by the receiving signal level calculation unit 25 is equal to or smaller than a predetermined threshold La. When the signal level L_{Rx} calculated by the receiving signal level calculation unit 25 is equal to or smaller than the predetermined threshold Lₜₕ, the step coefficient update unit 24 updates the step coefficient μ, for example, according to the above-described equation (2). In the meantime, when the signal level L calculated by the receiving signal level calculation unit 25 is larger than the predetermined threshold Lₜₕ, the step coefficient update unit 24 updates the step coefficient μ to 0.

Here, when the signal level L_{Rx} of the receiving signal Rx′ is relatively large, the accuracy of detection of the component of the PIM signal included in the receiving signal Rx′ becomes relatively low. Therefore, when the step coefficient μ is set to a value larger than 0, the compensation coefficient A updated by the compensation coefficient update unit 23 may not converge but diverge. In the meantime, when the signal level L_{Rx} of the receiving signal Rx′ is sufficiently large, it is possible to maintain high quality of receiving signal even when a PIM signal is present. Accordingly, when the signal level L_{Rx} of the receiving signal Rx′ is larger than the threshold Lₜₕ, by setting the step coefficient μ to 0, it is possible to suppress the compensation coefficient A from diverging, thereby suppressing deterioration of the quality of receiving signal.

[Process of Communication Device 10]

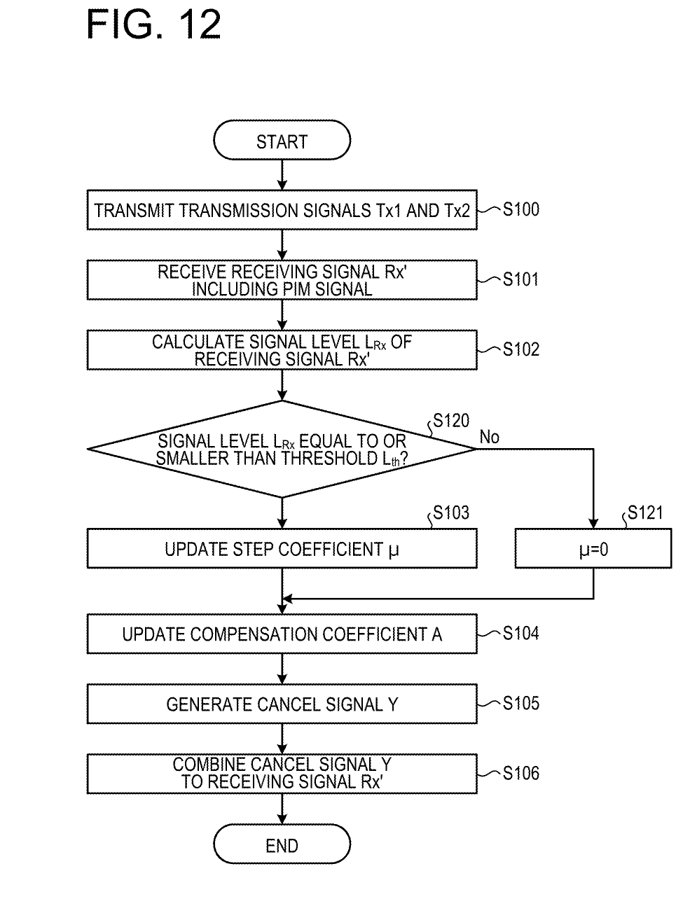

FIG. 12 is a flowchart illustrating an example of a process performed by the communication device 10 of the third embodiment. The communication device 10 performs the process illustrated in the flowchart of FIG. 12 every predetermined timing. In FIG. 12, steps denoted by the same reference numeral as in FIG. 7 have the same configurations as the steps illustrated in the flowchart of FIG. 7 and therefore, explanation of which will be omitted.

The step coefficient update unit 24 determines whether or not the signal level L_{Rx} calculated by the receiving signal level calculation unit 25 is equal to or smaller than a predetermined threshold Lₜₕ (S120). When it is determined that the signal level L_{Rx} calculated by the receiving signal level calculation unit 25 is equal to or smaller than the threshold Lₜₕ (“Yes” in S120), the step coefficient update unit 24 updates the step coefficient μ, for example, according to the above-described equation (2) (S103).

In the meantime, when it is determined that the signal level L_{Rx} calculated by the receiving signal level calculation unit 25 is larger than the threshold Lₜₕ (“No” in S120), the step coefficient update unit 24 updates the step coefficient μ to 0 (S121). Then, the compensation coefficient update unit 23 updates the compensation coefficient A using the step coefficient μ updated in the operation S103 or S121 (S104). Then, the communication device 10 performs the processes illustrated in the operations S105 and S106.

### Effects of Third Embodiment

The third embodiment has been described above. In the present embodiment, the step coefficient update unit 24 sets the step coefficient μ to 0 when the signal level of the receiving signal calculated by the receiving signal level calculation unit 25 is larger than the predetermined threshold. Accordingly, the communication device 10 can suppress the divergence of the compensation coefficient A and the deterioration of quality of receiving signal.

### Fourth Embodiment

In the above-described second embodiment, irrespective of a value of the ratio of the signal level L_{Rx} of the receiving signal Rx′ and the signal level L_{PIM} of the PIM signal included in the receiving signal Rx′, the step coefficient μ is updated based on the value of the ratio of the signal level L_{Rx} and the signal level L_{PIM}. In contrast, a fourth embodiment is different from the second embodiment in that the step coefficient μ is updated to 0 when the value of the ratio of the signal level L_{Rx} and the signal level L_{PIM} is larger than a predetermined threshold Rₜₕ. The following description is focused on the points different from the second embodiment. A communication device 10 in the fourth embodiment has the same configuration as the communication device 10 of the first embodiment described with reference to FIG. 1 and therefore, explanation of which will be omitted. In addition, excluding the points to be described below, a PIM cancel unit 20 in the fourth embodiment has the same configuration as the PIM cancel unit 20 of the second embodiment described with reference to FIG. 9 and therefore, explanation of which will be omitted.

The step coefficient update unit 24 of the present embodiment determines whether or not a value of the ratio of the signal level L_{Rx} calculated by the receiving signal level calculation unit 25 and the signal level L_{PIM} calculated by the PIM signal level calculation unit 27 is equal to or smaller than the predetermined threshold Rₜₕ. Specifically, the step coefficient update unit 24 determines whether or not a value of the ratio calculated by dividing the value of the signal level L_{PIM} by the value of the signal level L_{Rx} is equal to or smaller than the threshold Rₜₕ.

When the value of the ratio of the signal level L_{PIM} and the signal level L_{Rx} is equal to or smaller than the threshold Rₜₕ, the step coefficient update unit 24 updates the step coefficient μ, for example, according to the above-described equation (6). In the meantime, when the value of the ratio of the signal level L_{PIM} and the signal level L_{Rx} is larger than the threshold Rₜₕ, the step coefficient update unit 24 updates the step coefficient μ to 0.

In this way, when the value of the ratio of the signal level L_{PIM} and the signal level L_{Rx} is larger than the threshold Rₜₕ, the value of the step coefficient μ is adjusted according to the value of the ratio, whereby the convergence time may be shortened while the divergence of the compensation coefficient A is suppressed. In the meantime, when the value of the ratio of the signal level L_{PIM} and the signal level L_{Rx} is equal to or smaller than the threshold Rₜₕ, the value of the step coefficient μ is fixed at 0, thereby reliably suppressing the divergence of the compensation coefficient A. Accordingly, the communication device 10 may suppress the deterioration of quality of receiving signal.

[Process of Communication Device 10]

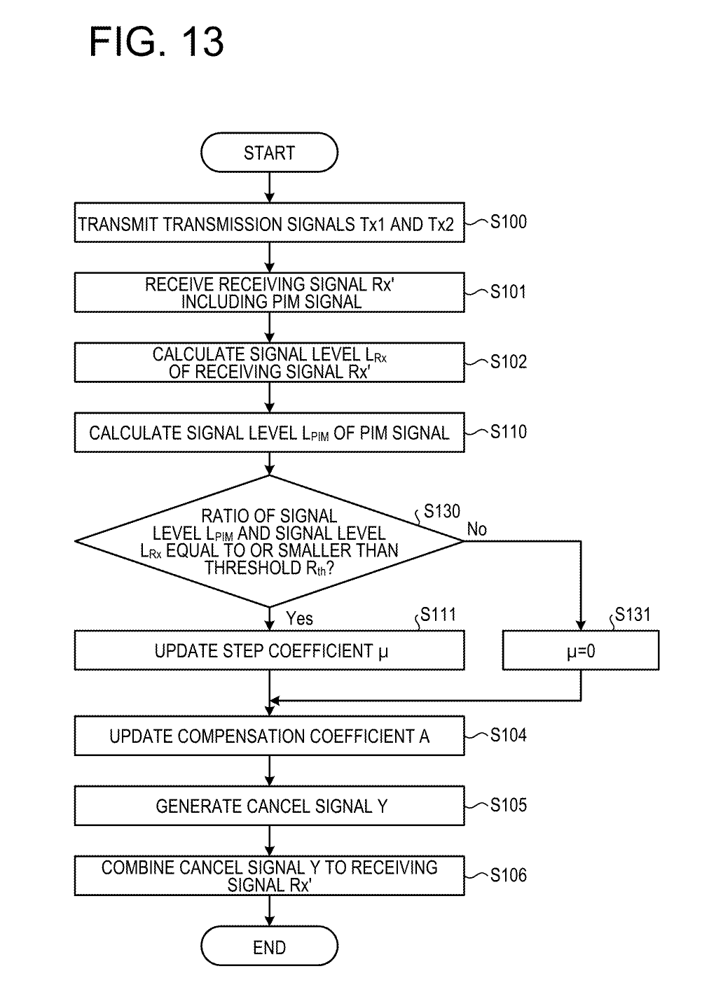

FIG. 13 is a flowchart illustrating an example of a process performed by the communication device 10 of the fourth embodiment. The communication device 10 performs the process illustrated in the flowchart of FIG. 13 every predetermined timing. In FIG. 13, steps denoted by the same reference numeral as in FIG. 10 have the same configurations as the steps illustrated in the flowchart of FIG. 10 and therefore, explanation of which will be omitted.

The step coefficient update unit 24 determines whether or not a value of the ratio of the signal level L_{Rx} calculated by the receiving signal level calculation unit 25 and the signal level L_{PIM} calculated by the PIM signal level calculation unit 27 is equal to or smaller than a predetermined threshold Rₜₕ (S130). When it is determined that the value of the ratio is equal to or smaller than the predetermined threshold Rₜₕ (“Yes” in S130), the step coefficient update unit 24 updates the step coefficient μ, for example, according to the above-described equation (6).

In the meantime, when it is determined that the value of the ratio is larger than the predetermined threshold Rₜₕ (“No” in S130), the step coefficient update unit 24 updates the step coefficient μ to 0 (S131). Then, the compensation coefficient update unit 23 updates the compensation coefficient A using the step coefficient μ updated in the operation S111 or S131 (S104). Then, the communication device 10 performs the processes illustrated in the operations S105 and S106.

### Effects of Fourth Embodiment

The fourth embodiment has been described above. In the present embodiment, the step coefficient update unit 24 sets the step coefficient μ to 0 when the value of the ratio of the signal level of the receiving signal calculated by the receiving signal level calculation unit 25 and the signal level of the PIM signal calculated by the PIM signal level calculation unit 27 is larger than the predetermined threshold. Accordingly, the communication device 10 may suppress the divergence of the compensation coefficient A and the deterioration of quality of receiving signal.

### Fifth Embodiment

In the above-described first embodiment, irrespective of the value of the signal level L_{Rx} of the receiving signal Rx′, the cancel signal Y is combined to the receiving signal Rx′. In contrast, a fifth embodiment is different from the first embodiment in that the combination of the cancel signal Y to the receiving signal Rx′ is stopped when the value of the signal level L_{Rx} of the receiving signal Rx′ is larger than the predetermined threshold Lₜₕ. The following description is focused on the points different from the first embodiment. A communication device 10 in the fifth embodiment has the same configuration as the communication device 10 of the first embodiment described with reference to FIG. 1 and therefore, explanation of which will be omitted.

[PIM Cancel Unit 20]

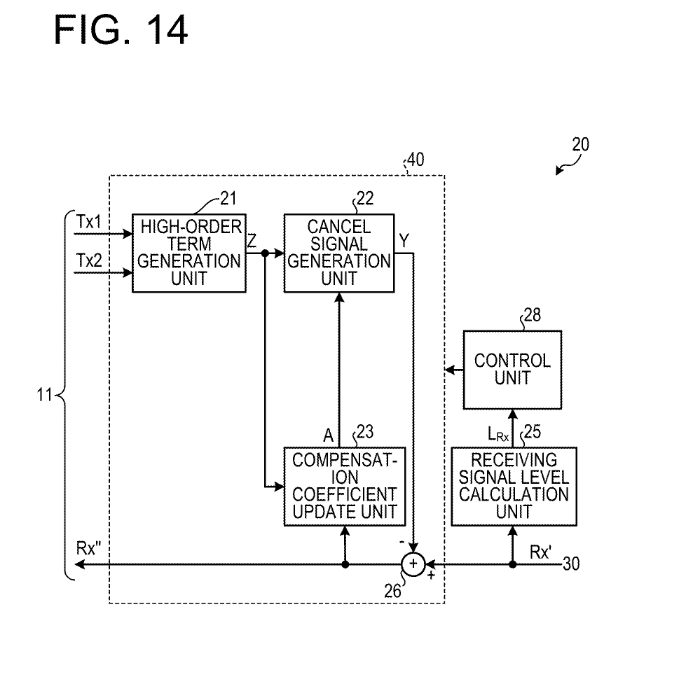

FIG. 14 is a block diagram illustrating an example of a PIM cancel unit 20 in the fifth embodiment. The PIM cancel unit 20 in the present embodiment includes a receiving signal level calculation unit 25, a control unit 28 and a cancel processing unit 40. The cancel processing unit 40 includes a high-order term generation unit 21, a cancel signal generation unit 22, a compensation coefficient update unit 23 and a combination unit 26. Excluding the points to be described below, in FIG. 14, the blocks denoted by the same reference numerals as those in FIG. 3 have the same or similar functions as the blocks in FIG. 3 and therefore, explanation of which will be omitted.

The compensation coefficient update unit 23 updates the compensation coefficient A, for example, according to the above-described equation (4), using a high-order term component Z calculated by the high-order term generation unit 21 and a preset step coefficient μ. In the present embodiment, the step coefficient μ is a fixed value which is preset in the compensation coefficient update unit 23 by a manager of the communication device 10.

The control unit 28 controls the operation and stop of the cancel processing unit 40 based on the signal level L_{Rx} calculated by the receiving signal level calculation unit 25. Specifically, the control unit 28 determines whether or not the signal level L_{Rx} calculated by the receiving signal level calculation unit 25 is equal to or smaller than a predetermined threshold L_{Rx}. When the signal level L_{Rx} calculated by the receiving signal level calculation unit 25 is equal to or smaller than the predetermined threshold L_{Rx}, the control unit 28 operates the cancel processing unit 40. Accordingly, the high-order term component Z of the PIM signal is calculated by the high-order term generation unit 21, the compensation coefficient A is updated by the compensation coefficient update unit 23, and the cancel signal Y is generated by the cancel signal generation unit 22. Then, the cancel signal Y is combined to the receiving signal Rx′ by the combination unit 26 and the receiving signal Rx″ after the combination is output to the BBU 11.

In the meantime, when the signal level L_{Rx} calculated by the receiving signal level calculation unit 25 is larger than the threshold Lₜₕ, the control unit 28 stops the cancel processing unit 40. When the cancel processing unit 40 is stopped, the combination unit 26 outputs the receiving signal Rx′, as Rx″, to the BBU 11.

Here, when the signal level L_{Rx} of the receiving signal Rx′ is large, the accuracy of detection of the component of the PIM signal included in the receiving signal Rx′ becomes low. Therefore, the compensation coefficient A updated by the compensation coefficient update unit 23 may not converge but diverge. In addition, when the signal level L_{Rx} of the receiving signal Rx′ is large, it is possible to maintain high quality of receiving signal even when the PIM signal is included in the receiving signal Rx′. Accordingly, when the signal level L_{Rx} of the receiving signal Rx′ is larger than the threshold Lₜₕ, by stopping the cancel processing unit 40, it is possible to suppress the compensation coefficient A from diverging, thereby suppressing the deterioration of quality of receiving signal. Further, when the signal level L_{Rx} of the receiving signal Rx′ is larger than the threshold Lₜₕ, by stopping the cancel processing unit 40, it is possible to reduce power consumption of the communication device 10.

[Process of Communication Device 10]

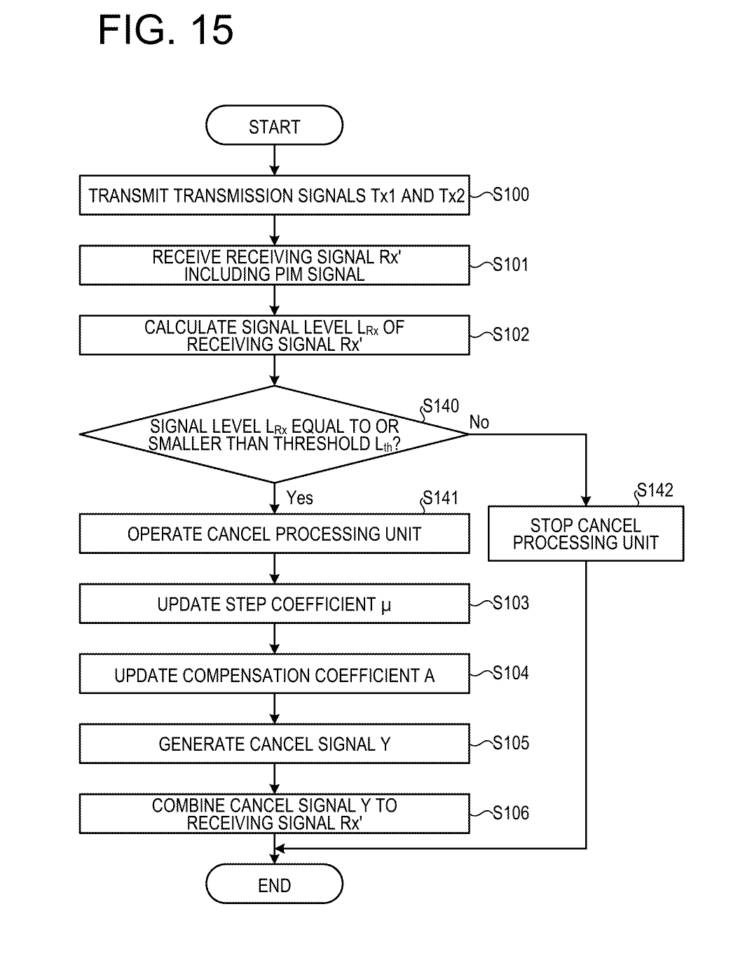

FIG. 15 is a flowchart illustrating an example of a process performed by the communication device 10 of the fifth embodiment. The communication device 10 performs the process illustrated in the flowchart of FIG. 15 every predetermined timing. In FIG. 15, steps denoted by the same reference numeral as in FIG. 7 have the same configurations as the steps illustrated in the flowchart of FIG. 7 and therefore, explanation of which will be omitted.

The control unit 28 determines whether or not the signal level L_{Rx} calculated by the receiving signal level calculation unit 25 is equal to or smaller than a predetermined threshold Lₜₕ (S140). When it is determined that the signal level L_{Rx} calculated by the receiving signal level calculation unit 25 is equal to or smaller than the threshold Lₜₕ (“Yes” in S140), the control unit 28 operates the cancel processing unit 40 (S141). Then, the communication device 10 performs the processes illustrated in the operations S103 to S106.

In the meantime, when it is determined that the signal level L_{Rx} calculated by the receiving signal level calculation unit 25 is larger than the threshold Lₜₕ (“No” in S140), the control unit 28 stops the cancel processing unit 40 (S142). Accordingly, the combination unit 26 outputs the receiving signal Rx′, as Rx″, to the BBU 11. Then, the communication device 10 ends the process illustrated in the present flowchart.

### Effects of Fifth Embodiment

The fifth embodiment has been described above. The communication device 10 of the present embodiment includes the RRH 30 and the PIM cancel unit 20. The RRH 30 transmits a plurality of transmission signals wirelessly transmitted at different frequencies. In addition, the RRH 30 receives a receiving signal including a PIM signal generated by the plurality of transmission signals. The PIM cancel unit 20 includes the receiving signal level calculation unit 25, the cancel processing unit 40 and the control unit 28. The receiving signal level calculation unit 25 calculates the signal level of the receiving signal received by the RRH 30. The cancel processing unit 40 cancels the PIM signal included in the receiving signal, based on the plurality of transmission signals transmitted by the RRH 30 and the receiving signal. The control unit 28 controls the operation and stop of the cancel processing unit 40 based on the signal level of the receiving signal calculated by the receiving signal level calculation unit 25. Accordingly, the communication device 10 may reduce the power consumption of the communication device 10 while maintaining high quality of receiving signal.

In addition, when the signal level of the receiving signal calculated by the receiving signal level calculation unit 25 is equal to or smaller than the predetermined threshold, the control unit 28 of the present embodiment operates the cancel processing unit 40. When the signal level of the receiving signal calculated by the receiving signal level calculation unit 25 is larger than the predetermined threshold, the control unit 28 of the present embodiment stops the cancel processing unit 40. Accordingly, the communication device 10 may reduce the power consumption of the communication device 10 while maintaining high quality of receiving signal.

### Sixth Embodiment

In the above-described second embodiment, irrespective of a value of the ratio of the signal level L_{Rx} of the receiving signal Rx′ and the signal level L_{PIM} of the PIM signal included in the receiving signal Rx′, the cancel signal Y is combined to the receiving signal Rx′. In contrast, a sixth embodiment is different from the second embodiment in that the combination of the cancel signal Y to the receiving signal Rx′ is stopped when the value of the ratio of the signal level L_{Rx} and the signal level L_{PIM} is larger than a predetermined threshold Rₜₕ. The following description is focused on the points different from the second embodiment. A communication device 10 in the sixth embodiment has the same configuration as the communication device 10 of the first embodiment described with reference to FIG. 1 and therefore, explanation of which will be omitted.

[PIM Cancel Unit 20]

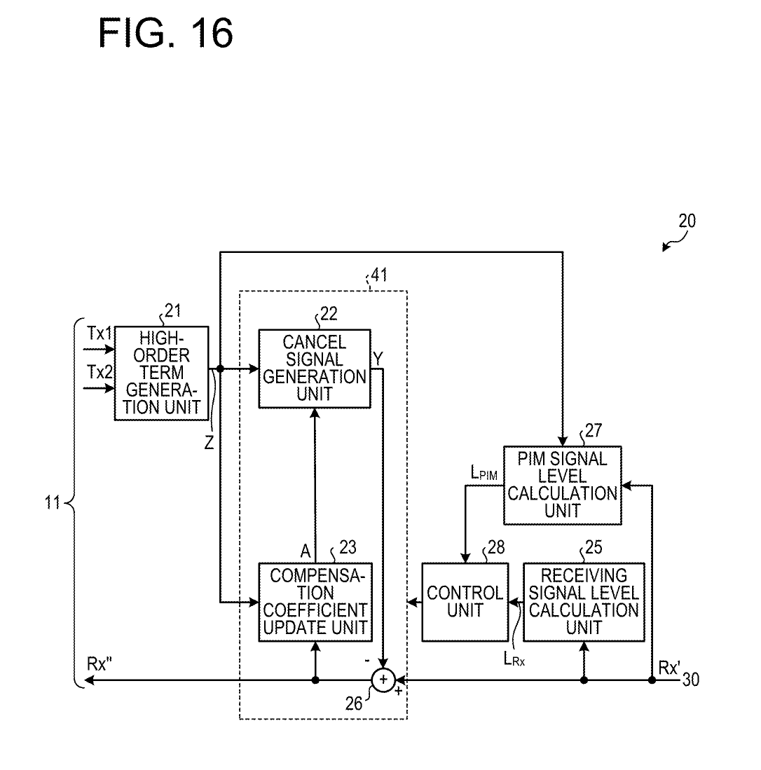

FIG. 16 is a block diagram illustrating an example of a PIM cancel unit 20 in the sixth embodiment. The PIM cancel unit 20 in the present embodiment includes a high-order term generation unit 21, a receiving signal level calculation unit 25, a PIM signal level calculation unit 27, a control unit 28, and a cancel processing unit 41. The cancel processing unit 41 includes a cancel signal generation unit 22, a compensation coefficient update unit 23, and a combination unit 26. Excluding the points to be described below, in FIG. 16, the blocks denoted by the same reference numerals as those in FIG. 9 have the same or similar functions as the blocks in FIG. 9 and therefore, explanation of which will be omitted.

The compensation coefficient update unit 23 updates the compensation coefficient A, for example, according to the above-described equation (4), using a high-order term component Z calculated by the high-order term generation unit 21 and a preset step coefficient μ. In the present embodiment, the step coefficient μ is a fixed value which is preset in the compensation coefficient update unit 23 by a manager of the communication device 10.

The control unit 28 determines whether or not a value of the ratio of the signal level L_{Rx} calculated by the receiving signal level calculation unit 25 and the signal level L_{PIM} calculated by the PIM signal level calculation unit 27 is equal to or smaller than the predetermined threshold Rₜₕ. Specifically, the control unit 28 determines whether or not a value of the ratio calculated by dividing the value of the signal level L_{PIM} by the value of the signal level L_{Rx} is equal to or smaller than the threshold Rₜₕ.

When the value of the ratio of the signal level L_{PIM} and the signal level L_{Rx} is equal to or smaller than the threshold Rₜₕ, the control unit 28 operates the cancel processing unit 41. Accordingly, the compensation coefficient A is updated by the compensation coefficient update unit 23 and the cancel signal Y is generated by the cancel signal generation unit 22. Then, the cancel signal Y is combined to the receiving signal Rx′ by the combination unit 26 and the receiving signal Rx″ after the combination is output to the BBU 11.

In the meantime, when the value of the ratio of the signal level L_{PIM} and the signal level L_{Rx} is larger than the threshold Rₜₕ, the control unit 28 stops the cancel processing unit 41. When the cancel processing unit 41 is stopped, the combination unit 26 outputs the receiving signal Rx′, as Rx″, to the BBU 11.

In this way, when the value of the ratio of the signal level L_{PIM} and the signal level L_{Rx} is larger than the threshold Rₜₕ, by operating the cancel processing unit 41, the convergence time may be shortened while the divergence of the compensation coefficient A is suppressed. When the value of the ratio of the signal level L_{PIM} and the signal level L_{Rx} is equal to or smaller than the threshold Rₜₕ, by stopping the cancel processing unit 41, the power consumption of the communication device 10 may be reduced.

[Process of Communication Device 10]

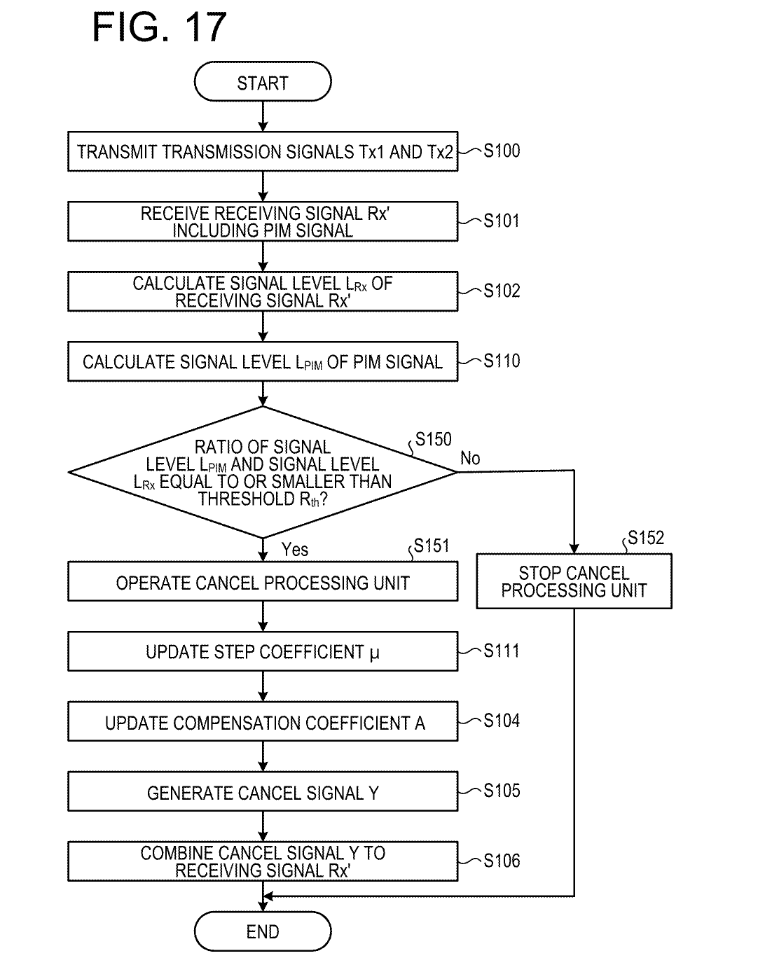

FIG. 17 is a flowchart illustrating an example of a process performed by the communication device 10 of the sixth embodiment. The communication device 10 performs the process illustrated in the flowchart of FIG. 17 every predetermined timing. In FIG. 17, steps denoted by the same reference numeral as in FIG. 10 have the same configurations as the steps illustrated in the flowchart of FIG. 10 and therefore, explanation of which will be omitted.

The control unit 28 determines whether or not a value of the ratio of the signal level L_{Rx} calculated by the receiving signal level calculation unit 25 and the signal level L_{PIM} calculated by the PIM signal level calculation unit 27 is equal to or smaller than a predetermined threshold Rₜₕ (S150). When it is determined that the value of the ratio is equal to or smaller than the threshold Rₜₕ (“Yes” in S150), the control unit 28 operates the cancel processing unit 41 (S151). Then, the communication device 10 performs the processes illustrated in the operations S111 and S104 to S106.

In the meantime, when it is determined that the value of the ratio of the signal level L_{Rx} calculated by the receiving signal level calculation unit 25 and the signal level L_{PIM} calculated by the PIM signal level calculation unit 27 is larger than the threshold Rₜₕ (“No” in S150), the control unit 28 stops the cancel processing unit 41 (S152). Accordingly, the combination unit 26 outputs the receiving signal Rx′, as Rx″, to the BBU 11. Then, the communication device 10 ends the process illustrated in the present flowchart.

### Effects of Sixth Embodiment

The sixth embodiment has been described above. The control unit 28 of the present embodiment stops the cancel processing unit 41 when the value of the ratio of the signal level of the receiving signal calculated by the receiving signal level calculation unit 25 and the signal level of the PIM signal calculated by the PIM signal level calculation unit 27 is larger than the predetermined threshold. Accordingly, the communication device 10 may reduce the power consumption of the communication device 10 while suppressing the divergence of the compensation coefficient A.

### Seventh Embodiment

In the above-described second, fourth and sixth embodiments, the receiving signal level calculation unit 25 calculates the signal level L_{Rx} of the receiving signal Rx′, for example, according to the above-described equation (1). In addition, in the above-described second, fourth and sixth embodiments, the PIM signal level calculation unit 27 calculates the signal level L_{PIM} of the PIM signal included in the receiving signal Rx′, for example, according to the above-described equation (5). In contrast, in the present embodiment, the signal level L_{Rx} and the signal level L_{PIM} are calculated by a method different from those in the above-described second, fourth and sixth embodiments.

The following description is focused on the points different from the second embodiment. The method of calculating the signal level L_{Rx} and the signal level L_{PIM} in the present embodiment may also be applied to the fourth embodiment and the sixth embodiment. A communication device 10 in the seventh embodiment has the same configuration as the communication device 10 of the first embodiment described with reference to FIG. 1 and therefore, explanation of which will be omitted.

[PIM Cancel Unit 20]

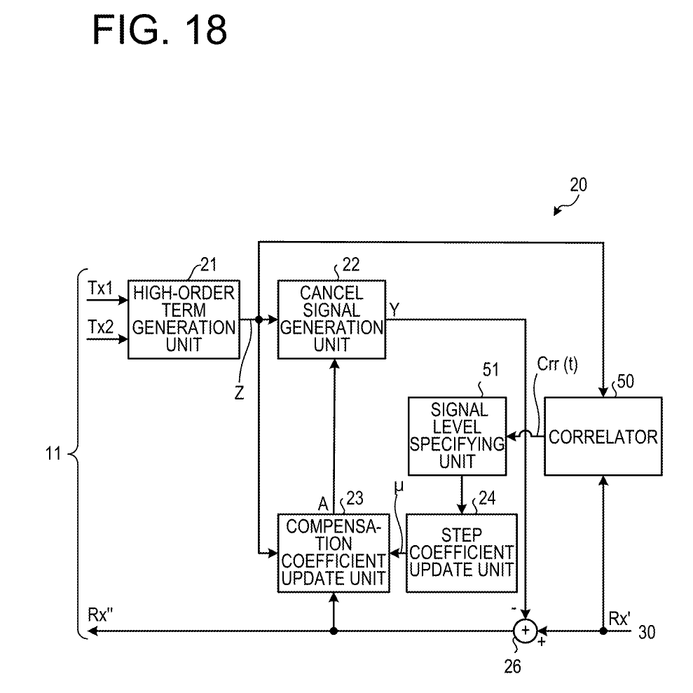

FIG. 18 is a block diagram illustrating an example of a PIM cancel unit 20 in the seventh embodiment. The PIM cancel unit 20 in the present embodiment includes a high-order term generation unit 21, a cancel signal generation unit 22, a compensation coefficient update unit 23, a step coefficient update unit 24, a combination unit 26, a correlator 50, and a signal level specifying unit 51. Excluding the points to be described below, in FIG. 18, the blocks denoted by the same reference numerals as those in FIG. 9 have the same or similar functions as the blocks in FIG. 9 and therefore, explanation of which will be omitted.

The correlator 50 calculates a correlation value Crr between the receiving signal Rx′ and the high-order term component Z in the PIM signal calculated by the high-order term generation unit 21 while changing a delay timing of the high-order term component Z with respect to the receiving signal Rx′. Then, the correlator 50 outputs a set of correlation values Crr calculated at different delay timings, as a delay profile Crr(t) of the PIM signal, to the signal level specifying unit 51.

The signal level specifying unit 51 specifies a value of the peak of the correlation value as the signal level L_{PIM} of the PIM signal by referring to the delay profile Crr(t) output from the correlator 50. In addition, the signal level specifying unit 51 specifies a correlation value at a delay timing apart by a predetermined time from the delay timing of the peak correlation value, as the signal level L_{Rx} of the receiving signal Rx′, by referring to the delay profile Crr(t) output from the correlator 50.

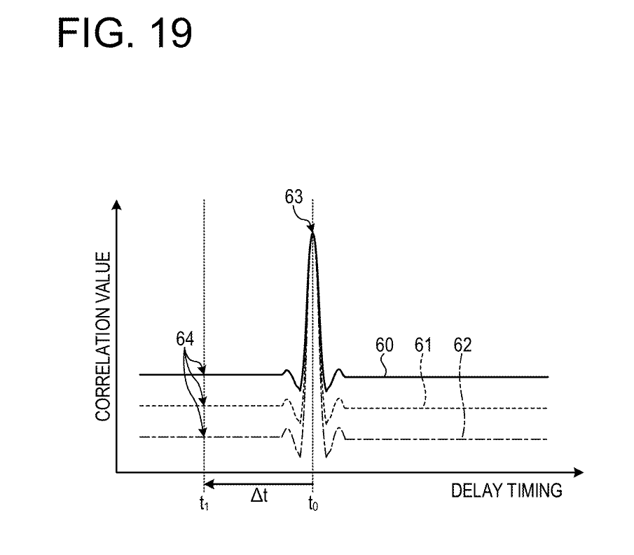

FIG. 19 is a view illustrating an example of the delay profile. In FIG. 19, reference numeral 60 denotes a delay profile when the signal level of the receiving signal Rx′ is large. In FIG. 19, reference numeral 61 denotes a delay profile when the signal level of the receiving signal Rx′ is smaller than the signal level of the receiving signal Rx′ when the delay profile denoted by reference numeral 60 is calculated. In FIG. 19, reference numeral 62 denotes a delay profile when the signal level of the receiving signal Rx′ is smaller than the signal level of the receiving signal Rx′ when the delay profile denoted by reference numeral 61 is calculated.

In each delay profile, for example, as illustrated in FIG. 19, the correlation value peak 63 is formed at a predetermined delay timing t₀. When the signal levels of PIM signals included in receiving signals Rx′ having different signal levels are equal, correlation values at the peak 63 become almost equal. Accordingly, the signal level specifying unit 51 in the present embodiment specifies the value of the correlation value peak 63 as the value of the signal level L_{PIM} of the PIM signal included in the receiving signal Rx′.

In addition, a receiving signal Rx received from a wireless terminal or the like of the communication counterpart, which is included in the receiving signal Rx′, is uncorrelated with the high-order term component Z in the PIM signal. Therefore, in each delay profile, for example, as illustrated in FIG. 19, a residual error at delay timings other than the delay timing t₀ at which the peak 63 is formed depends on the magnitude of the receiving signal Rx received from the wireless terminal or the like of the communication counterpart.

Therefore, the signal level specifying unit 51 of the present embodiment refers to the delay profile output from the correlator 50 to specify a correlation value 64 at a delay timing t₁ apart by a predetermined time Δt from the delay timing t₀ of the correlation value peak 63, as the value of the signal level L_{Rx} of the receiving signal Rx′. For example, when the communication device 10 in the present embodiment is used in a long term evolution (LTE) radio communication system, the value of Δt may be equal to or greater than, for example, one symbol period. In addition, the signal level specifying unit 51 may specify an average of correlation values at different delay timings apart by the predetermined time Δt from the delay timing t₀ of the correlation value peak 63, as the value of the signal level L_{Rx} of the receiving signal Rx′.

[Process of Communication Device 10]

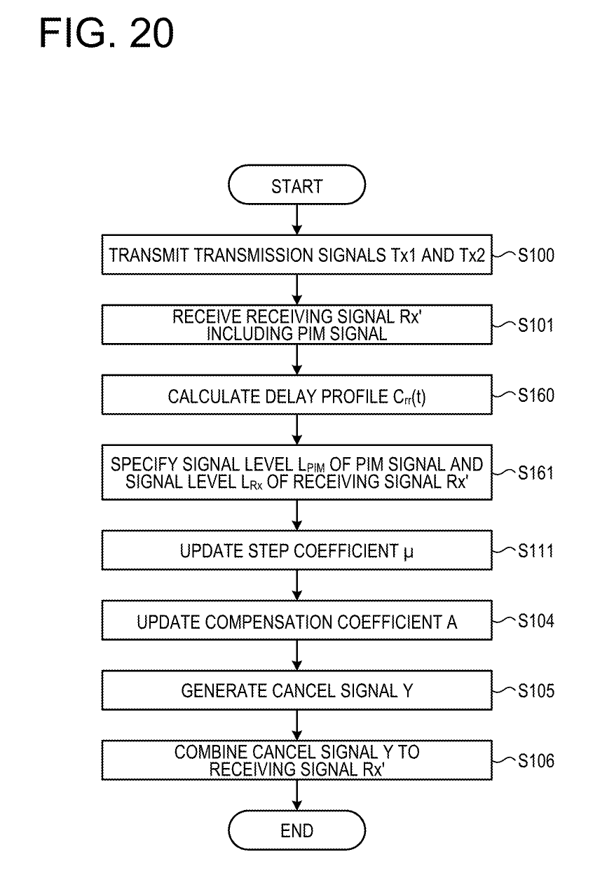

FIG. 20 is a flowchart illustrating an example of a process performed by the communication device 10 of the seventh embodiment. The communication device 10 performs the process illustrated in the flowchart of FIG. 20 every predetermined timing. In FIG. 20, steps denoted by the same reference numeral as in FIG. 10 have the same configurations as the steps illustrated in the flowchart of FIG. 10 and therefore, explanation of which will be omitted.

The correlator 50 calculates a correlation value between the receiving signal Rx′ and the high-order term component Z while changing a delay timing of the high-order term component Z in the PIM signal calculated by the high-order term generation unit 21 with respect to the receiving signal Rx′. For example, a sliding correlator may be used as the correlator 50. Then, the correlator 50 outputs a set of correlation values calculated at different delay timings, as a delay profile Crr(t) of the PIM signal, to the signal level specifying unit 51 (S160).

Next, the signal level specifying unit 51 specifies a value of the peak of the correlation value as the signal level L_{PIM} of the PIM signal by referring to the delay profile Crr(t) output from the correlator 50 (S161). In addition, the signal level specifying unit 51 specifies a correlation value at a delay timing apart by a predetermined time from the delay timing of the peak correlation value, as the signal level L_{Rx} of the receiving signal Rx′, by referring to the delay profile Crr(t) output from the correlator 50 (S161). Then, the communication device 10 performs the processes illustrated in the operations S111 and S104 to S106.

### Effects of Seventh Embodiment

The seventh embodiment has been described above. With the communication device 10 of the present embodiment, it is possible to calculate the signal level L_{Rx} of the receiving signal Rx′ and the signal level L_{PIM} of the PIM signal included in the receiving signal Rx′ using a simpler method. Accordingly, it is possible to reduce the circuit scale of the communication device 10.

[Hardware]

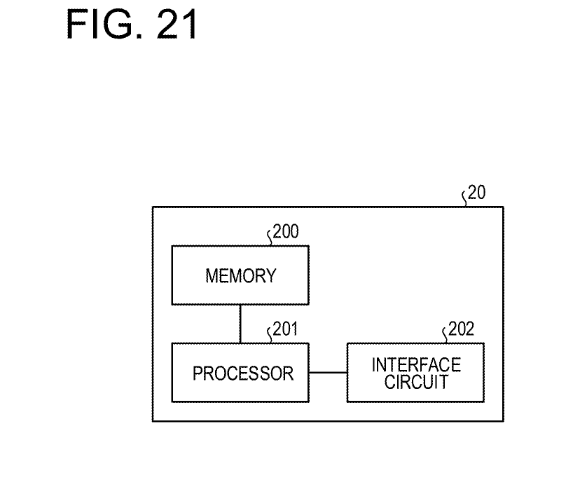

FIG. 21 is a view illustrating an example of hardware of the PIM cancel unit 20. For example, as illustrated in FIG. 21, the PIM cancel unit 20 includes a memory 200, a processor 201, and an interface circuit 202.

The interface circuit 202 exchanges signals with the BBU 11 and the RRH 30 in accordance with the communication standard such as a common public radio interface (CPRI). The memory 200 stores programs, data, or the like for implementing the functions of the PIM cancel unit 20. The processor 201 executes a program read out from the memory 200 and cooperates with the interface circuit 202 and the like to implement the functions of the PIM cancel unit 20, for example, the high-order term generation unit 21, the cancel signal generation unit 22, the compensation coefficient update unit 23, the step coefficient update unit 24, the receiving signal level calculation unit 25, the combination unit 26, the PIM signal level calculation unit 27, the control unit 28, the correlator 50, the signal level specifying unit 51, and the like.

[Others]

However, the present disclosure is not limited to the above-described embodiments but various modifications may be made within the spirit and scope of the present disclosure.

For example, the arithmetic processing performed in each of the above-described first to seventh embodiments may be performed in synchronization with a transmission signal. Accordingly, it is expected that the accuracy of values calculated in each arithmetic processing may be improved. For example, when the communication device 10 is used in an LTE radio communication system, the communication device 10 exchanges signals with a wireless terminal of a communication counterpart in a predetermined format such as a frame, a sub-frame, a slot, a symbol or the like. Therefore, the communication device 10 may take synchronization with the signals exchanged with the wireless terminal or the like of the communication counterpart and then execute a series of various arithmetic processing disclosed in each of the above-described first to seventh embodiments in the unit of format of these signals. The various arithmetic processing includes, for example, data integration, correlation operation, control of the step coefficient μ, and so on.

In addition, in the above-described first and third embodiments, the step coefficient update unit 24 may update the step coefficient μ using a value obtained by averaging the signal levels L_{Rx} calculated by the receiving signal level calculation unit 25 for a predetermined period. In addition, in the above-described second and fourth embodiments, the step coefficient update unit 24 may update the step coefficient μ using a value obtained by averaging the signal levels L_{Rx} calculated by the receiving signal level calculation unit 25 for a predetermined period and a value obtained by averaging the signal levels Lm calculated by the PIM signal level calculation unit 27 for a predetermined period. Accordingly, it may be expected that the step coefficient μ is controlled with higher accuracy.

In addition, in the above-described third embodiment, the step coefficient update unit 24 may update the value of the step coefficient μ to 0 when determination that a value of the signal level L_{Rx} of the receiving signal Rx′ is larger than the threshold Lₜₕ is successively made a predetermined number of times. In the above-described fourth embodiment, the step coefficient update unit 24 may update the value of the step coefficient μ to 0 when determination that a value of the ratio of the signal level L_{Rx} of the receiving signal Rx′ and the signal level L_{PIM} of the PIM signal is larger than the threshold value Rₜₕ is successively made a predetermined number of times. Accordingly, it is possible to improve the reliability of the communication device 10.

In each of the above-described first to seventh embodiments, the signal level L_{Rx} of the receiving signal Rx′ has been illustrated with the amplitude of the receiving signal Rx′. In addition, in each of the above-described first to seventh embodiments, the signal level L_{PIM} of the PIM signal included in the receiving signal Rx′ has been illustrated with the amplitude of the PIM signal. However, the present disclosure is not limited thereto. As another example, power of the receiving signal Rx′ may be used as the signal level L_{Rx} of the receiving signal Rx′ and power of the PIM signal may be used as the signal level L_{PIM} of the PIM signal included in the receiving signal Rx′.

In addition, in the above-described second, fourth, sixth and seventh embodiments, a variety of controls are executed based on the value of the ratio of the signal level L_{Rx} of the receiving signal Rx′ and the signal level L_{PIM} of the PIM signal included in the receiving signal Rx′. However, the present disclosure is not limited thereto. As another example, when the value of the signal level L_{Rx} of the receiving signal Rx′ and the value of the signal level L_{PIM} of the PIM signal are both expressed in decibel, a variety of controls may be executed based on a difference between the signal level L_{Rx} and the signal level L_{PIM}.

In addition, in the above-described fifth and sixth embodiments, the step coefficient μ used by the compensation coefficient update unit 23 is a fixed value, but the present disclosure is not limited thereto. For example, in the above-described fifth embodiment, the value of the step coefficient μ may be updated based on the value of the signal level L_{Rx} of the receiving signal Rx′ in the same manner as in the above-described first embodiment. In addition, in the above-described sixth embodiment, the value of the step coefficient μ may be updated based on the value of the ratio of the signal level L_{Rx} of the receiving signal Rx′ and the signal level L_{PIM} of the PIM signal in the same manner as in the above-described second embodiment.

In addition, in each of the above-described first to seventh embodiments, the PIM cancel unit 20 is provided as a separate device from the BBU 11 and the RRH 30 in the communication device 10. However, the present disclosure is not limited thereto. For example, the PIM cancel unit 20 may be provided in the BBU 11 or in each RRH 30. In addition, the PIM cancel unit 20 may also be implemented as a separate device from the communication device 10.

Further, in each of the above-described first to seventh embodiments, the PIM cancel unit 20 is provided in the communication device 10 that operates as a wireless base station, but the present disclosure is not limited thereto. For example, the PIM cancel unit 20 may be provided in the communication device 10 that operates as a wireless terminal.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication device comprising:
a plurality of transmitters, a transmitter of the plurality of transmitters configured to transmit a radio transmission signal having a frequency different from a frequency of a radio transmission signal transmitted by another transmitter of the plurality of transmitters;
a plurality of receivers, a receiver of the plurality of receivers configured to receive a receiving signal including a primary signal and a first passive intermodulation signal generated by a plurality of radio transmission signals;
a memory; and
a processor coupled to the memory and the processor configured to:
calculate a power of the primary signal;
update a first coefficient for generating a cancel signal for canceling the first passive intermodulation signal, based on the receiving signal and a plurality of transmission signals to be transmitted by the plurality of transmitters;
generate the cancel signal based on the plurality of transmission signals and the first coefficient; and
combine the receiving signal and the cancel signal,
wherein the processor is further configured to adjust a step coefficient, which is a time constant in case of updating the first coefficient, based on the power of the calculated primary signal.

2. The communication device according to claim 1,
wherein the processor is configured to adjust the step coefficient to be smaller as the power of the calculated primary signal becomes larger, and adjust the step coefficient to be larger as the power of the calculated primary signal becomes smaller.

3. The communication device according to claim 2,
wherein the processor is configured to set the step coefficient to 0 when the power of the calculated primary signal is larger than a predetermined value.

4. The communication device according to claim 1,
wherein the processor is further configured to:
calculate a correlation value between a power of a second passive intermodulation signal generated by the plurality of transmission signals and the power of the receiving signal, and
calculate a power of the first passive intermodulation signal by dividing the correlation value by a power of the second passive intermodulation signal, and
adjust the step coefficient to be smaller as a ratio or difference between the power of the calculated primary signal and the calculated power of the first passive intermodulation signal becomes larger, and adjust the step coefficient to be larger as the ratio or difference becomes smaller.

5. The communication device according to claim 4,
wherein the processor is configured to set the step coefficient to 0 when the ratio or difference is larger than a predetermined value.

6. A communication device comprising:
a plurality of transmitters, a transmitter of the plurality of transmitters configured to transmit a radio transmission signal having a frequency different from a frequency of a radio transmission signal transmitted by another transmitter of the plurality of transmitters;
a plurality of receivers, a receiver of the plurality of receivers configured to receive a receiving signal including a primary signal and a first passive intermodulation signal generated by a plurality of radio transmission signals;
a memory; and
a processor coupled to the memory and the processor configured to:
calculate a power of the primary signal; and
cancel the first passive intermodulation signal, based on the calculated power primary signal and a plurality of transmission signals to be transmitted by the plurality of transmitters.

7. The communication device according to claim 6,
wherein the processor is configured to cancel the first passive intermodulation signal when the power of the calculated primary signal is equal to or smaller than a predetermined value, and not cancel the first passive intermodulation signal when the power of the calculated primary signal is larger than the predetermined value.

8. The communication device according to claim 6,
wherein the processor is further configured to:
calculate a correlation value between a power of a second passive intermodulation signal generated by the plurality of transmission signals and the power of the receiving signal, and
calculate a power of the first passive intermodulation signal by dividing the correlation value by a power of the second passive intermodulation signal, and
cancel the first passive intermodulation signal when a ratio or difference between the power of the calculated primary signal and the calculated power of the first passive intermodulation signal is equal to or smaller than a predetermined value, and not cancel the first passive intermodulation signal when the ratio or difference is larger than the predetermined value.

9. A receiving method comprising:
transmitting a radio transmission signal having a frequency different from a frequency of a radio transmission signal transmitted by another transmitter of a plurality of transmitters, by a transmitter of a plurality of transmitters;
receiving a receiving signal including a primary signal and a first passive intermodulation signal generated by a plurality of radio transmission signals, by a receiver of a plurality of receivers;
calculating a power of the primary signal, by a processor;
updating a first coefficient for generating a cancel signal for canceling the first passive intermodulation signal, based on the receiving signal and a plurality of transmission signals to be transmitted by the plurality of transmitters, by the processor;
generating the cancel signal based on the plurality of transmission signals and the first coefficient, by the processor; and
combining the receiving signal and the cancel signal, by the processor,
wherein the processor further adjusts a step coefficient, which is a time constant in case of updating the first coefficient, based on the power of the calculated primary signal.
